(19) United States
(12) Patent Application Publication
(10) Pub. No.: US 2013/0294054 A1
(43) Pub. Date: Nov. 7, 2013

(54) DISPENSER OF OFFICE SUPPLIES WITH ILLUMINATED COVER

(71) Applicant: ILLINOIS TOOL WORKS INC., Glenview, IL (US)

(72) Inventors: Diane R. Laegeler, Lake in the Hills, IL (US); Chong S. Kim, Hoffman Estates, IL (US); Jakab A. Nyiri, Chicago, IL (US); Cary P. Moreth, Bloomingdale, IL (US)

(73) Assignee: ILLINOIS TOOL WORKS INC., Glenview, IL (US)

(21) Appl. No.: 13/787,015

(22) Filed: Mar. 6, 2013

Related U.S. Application Data
(60) Provisional application No. 61/643,856, filed on May 7, 2012.

(51) Int. Cl. F21V 33/00

(52) U.S. Cl. CPC F21V 33/0048
USPC 362/154

(57) ABSTRACT

Dispensers and methods of illuminating the same are provided. In one aspect, a dispenser includes a translucent cover, a light source, and a housing including a base and four sidewalls extending from the base forming a chamber adapted to contain at least one piece of office supplies. The translucent cover connects with the housing and overlies the chamber. The translucent cover includes a top surface, a bottom surface opposed to the top surface, and an edge surface between the top and bottom surfaces. The light source is mounted adjacent the edge surface. The light source is aimed at the edge surface such that light emitted by the light source is directed through the edge surface in order to illuminate the translucent cover. In another aspect, a method of illuminating a dispenser includes directing light from a powered light source through an edge surface of a translucent cover of the dispenser.

### RELATED APPLICATIONS

The present application claims the benefit of co-pending U.S. Provisional Patent Application No. 61/643,856, filed May 7, 2012, the entire contents of which is incorporated herein by reference.

### FIELD OF THE INVENTION

The present disclosure generally relates to dispensers of office supplies and, more particularly, to dispensers of office supplies that are more perceivable in darkened environments.

### BACKGROUND

Certain users like to maintain a pad of stationary on their desktop, such as a pad of self-adhering stationary. Self-adhering stationary, also known as a sticky note, is a piece of stationery with a re-adherable strip of adhesive on a back side, designed for temporarily attaching notes to documents and other surfaces. One of the most common brands of self-adhering stationary is the POST-IT™ notes brand of self-adhering stationary manufactured by the 3M Company of St. Paul, Minn. Although now available in a wide range of colors, shapes, and sizes, self-adhering stationary are most commonly a 3-inch (76 mm) square, canary yellow in color. A unique low-tack adhesive allows the self-adhering stationary to be easily attached and removed without leaving marks or residue. Typically pieces of self-adhering stationary are stacked to form a pad of about one-hundred notes. The notes may be stacked in a fan-folded arrangement with the re-adherable strips of adhesive having alternating positions, or a standard arrangement with all the re-adherable strips positioned identically.

Often times, users prefer to maintain pads of self-adhering stationary in a dispenser. Such dispensers may be difficult to find in a darkened environment.

It would therefore be desirable to have a dispenser which is more easily accessible in a darkened environment and which allow a user to more readily obtain individual pieces of stationary in the darkened environment.

### SUMMARY

The present disclosure is defined by the following claims, and nothing in this section should be taken as a limitation on those claims.

In one aspect, a stationary dispenser is provided. The stationary dispenser includes, but is not limited to, a housing having a base and four sidewalls extending from the base forming a chamber sized to contain a pad of stationary, a translucent cover, and a light source. The translucent cover is movably connected with the housing and overlying the chamber. The translucent cover includes a top surface opposed to a bottom surface and surrounded by an edge surface. The translucent cover forms a dispensing opening from the top surface to the bottom surface through which at least a single piece of stationary may pass. The light source is mounted adjacent the edge surface. The light source is configured to direct light into the translucent cover through the edge surface in order to illuminate the translucent cover.

In another aspect, a method for illuminating a dispenser is provided. The dispenser forms a chamber sized to contain office supplies and includes a translucent cover overlying the chamber. The method includes, but is not limited to, directing light from a powered light source through an edge surface of the translucent cover in order to illuminate the translucent cover.

In a further aspect, a dispenser is provided. The dispenser includes, but is not limited to, a housing having a base and four sidewalls extending from the base forming a chamber sized to contain at least one individual piece of office supplies, a translucent cover, and a light source. The translucent cover is connected with the housing and overlies the chamber. The translucent cover includes a top surface opposed to a bottom surface and surrounded by an edge surface. The light source is mounted adjacent the edge surface. The light source is aimed at the edge surface such that light emitted by the light source is directed through the edge surface, into and through the translucent cover, and to a second or same edge surface in order to illuminate the translucent cover.

In still another aspect, a stationary dispenser is provided and includes a housing including a base and four sidewalls extending from the base forming a chamber sized to contain a pad of stationary. The chamber includes an open end. The dispenser also includes a translucent cover movably connected with the housing and at least partially positioned in the open end of the chamber. The translucent cover includes a first surface, a second surface opposed to the first surface, and a third surface between the first surface and the second surface. The translucent cover defines an opening therein from the first surface to the second surface through which at least a single piece of stationary may pass. The dispenser further includes a light source mounted adjacent the third surface. The light source is configured to direct light into the translucent cover through the third surface in order to illuminate the translucent cover.

In still a further aspect, a method of illuminating a dispenser is provided. The dispenser defines a chamber adapted to contain office supplies and includes a translucent cover overlying the chamber. The method includes directing light from a powered light source through an edge surface of the translucent cover in order to illuminate the translucent cover.

In yet another aspect, a dispenser is provided and includes a housing, a translucent cover, and a light source. The housing includes a base and four sidewalls extending from the base forming a chamber sized to contain at least one individual piece of office supplies. The translucent cover is connected with the housing and overlies the chamber. The translucent cover includes a top surface, a bottom surface opposed to the top surface, and an edge surface between the top surface and the bottom surface. The light source is mounted adjacent the edge surface and the light source is aimed at the edge surface such that light emitted by the light source is directed through the edge surface in order to illuminate the translucent cover.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 depicts a top perspective view of a dispenser for dispensing office supplies, in accordance with one embodiment.

FIG. 2 depicts a top perspective view of a translucent cover surrounded by a frame of the dispenser shown in FIG. 1, in accordance with one embodiment.

FIG. 3 depicts a top perspective view of a housing of the dispenser shown in FIG. 1, the housing forms a chamber sized to contain office supplies, in accordance with one embodiment.

FIG. 4 depicts a bottom perspective view of the translucent cover and frame shown in FIG. 2, in accordance with one embodiment.

FIG. 5 depicts a top perspective view of the dispenser shown in FIG. 1 with office supplies contained therein, the dispenser adapted to dispense office supplies, in accordance with one embodiment.

FIG. 6 depicts an exploded perspective view of the dispenser shown in FIG. 1, office supplies, and an external device, in accordance with one embodiment.

FIG. 7 depicts a cross-sectional view along line 5-5 of the empty dispenser shown in FIG. 1, in accordance with one embodiment.

### DETAILED DESCRIPTION

Exemplary methods and devices consistent with the present disclosure may include a dispenser including a housing for storing office supplies such as a pad of stationary, a translucent cover covering the chamber, and a light source mounted adjacent to an edge surface of the translucent cover with the light source configured to illuminate the translucent cover. By illuminating the translucent cover, the dispenser is more easily perceived and accessible in a darkened environment, and allows a user to more readily obtain individual pieces of stationary in the darkened environment.

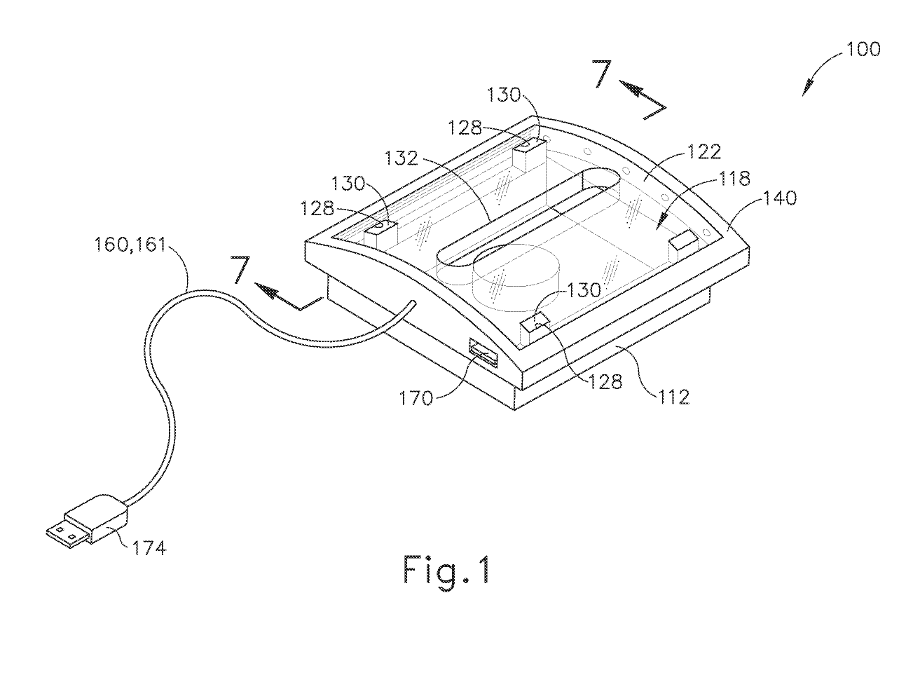

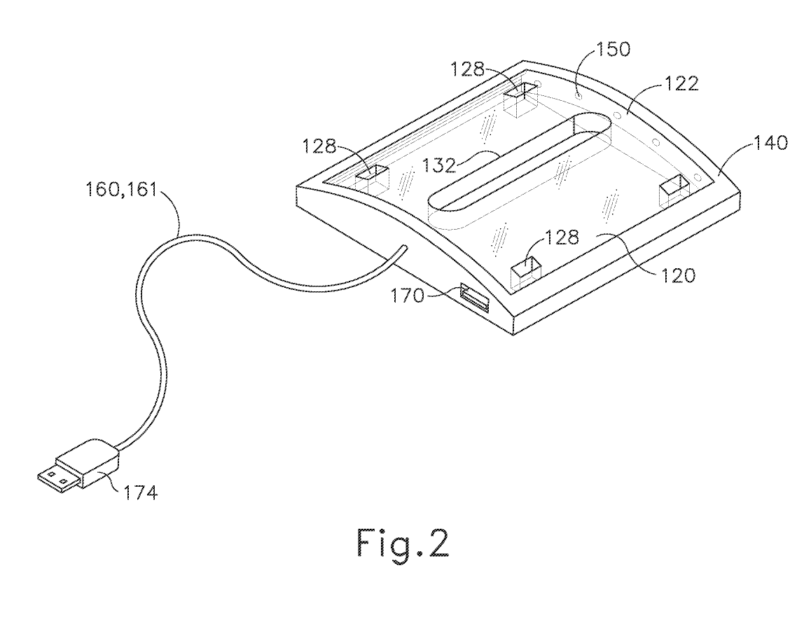

With reference to FIGS. 1-5, there is shown one exemplary embodiment of a dispenser 100 for housing and dispensing office supplies 102. Office supplies 102 may include any one of a variety of different office supplies. Exemplary office supplies may include items commonly found in a user's office such as, for example, writing utensils, pens, pencils, paperclips, stationary, binder clips, and tape. In the illustrated exemplary embodiment, stationary 108 is the exemplary office supplies dispensed from the dispenser 100.

The dispenser 100 may be designed for housing and dispensing a variety of office supplies 102 or one specific type of office supplies 102. For example, dispenser 100 may be a stationary dispenser 104 for housing and dispensing a pad 106 of stationary 108, such as, for example, self-adhering stationary 109, having a re-adherable strip of adhesive 111 on a back side of the stationary 109.

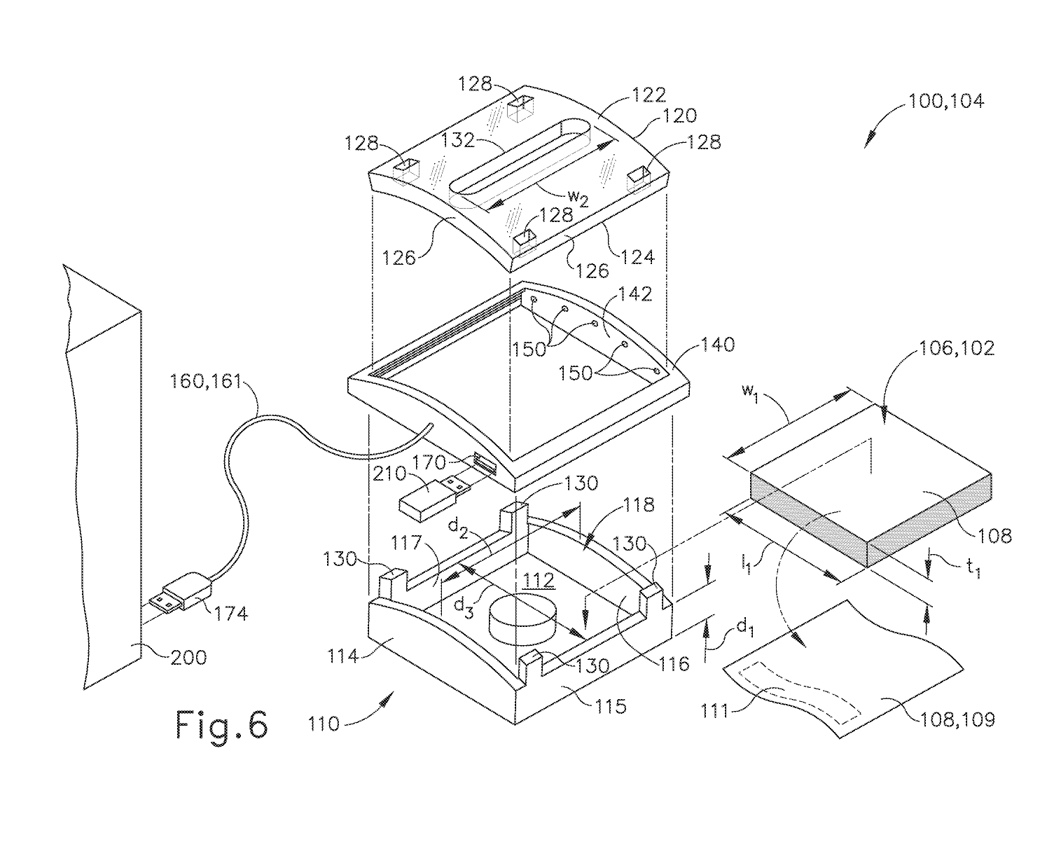

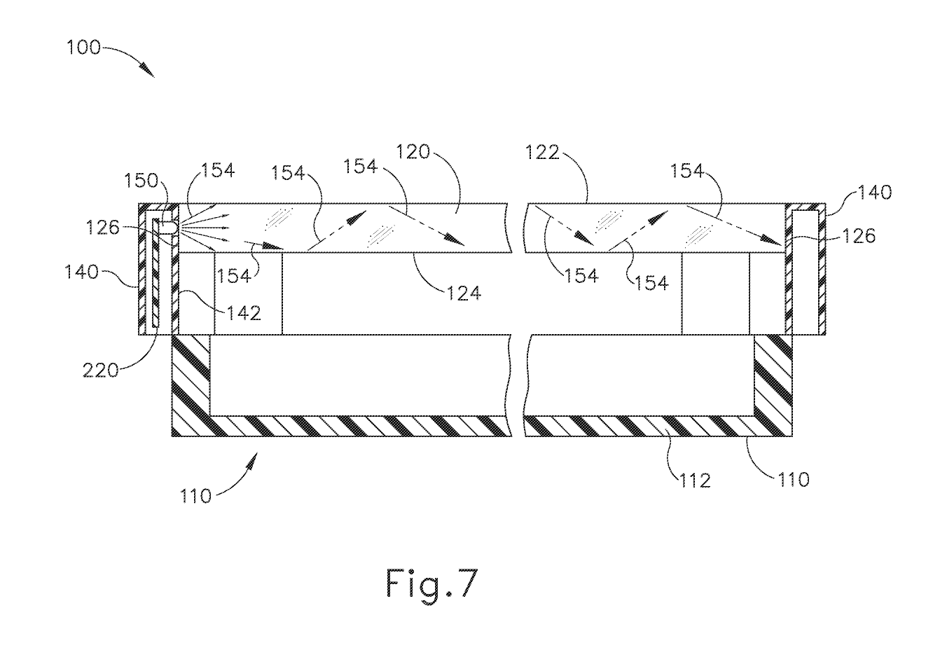

With continued reference to FIGS. 1-5 and additional reference to FIGS. 6 and 7, dispenser 100 includes a housing 110 having a base 112 and four sidewalls 114, 115, 116, and 117 extending from the base 112, a translucent cover 120, a frame 140, and a light source 150. In some exemplary embodiments, the base 112 may be weighted to provide stability and inhibit the dispenser 100 from moving. In some exemplary embodiments, the weight of the base 112 may be greater than about 100 grams. In other exemplary embodiments, the weight of the base 112 may be greater than about 200 grams.

The sidewalls 114, 115, 116, and 117 extend from the base 112 to form a chamber 118 sized to contain at least one individual piece of office supplies 102, and, in some cases, a plurality of office supplies 102. Each side wall 114, 115, 116, and 117 extends a distance d₁ (see FIG. 6) from the base 112 which is equal to or greater than a thickness t of at least one individual piece of office supplies 102. In some exemplary embodiments, the distance d₁ may be greater than the thickness t by about 5% to about 25%. A distance d₂ (see FIG. 6) between opposing sidewalls 114 and 116 may be equal to or greater than a width w of at least one individual piece of office supplies 102. In some exemplary embodiments, the distance d₂ may be greater than the width w by about 5% to about 25%. A distance d₃ (see FIG. 6) between opposing sidewalls 115 and 117 may be equal to or greater than a length 1 of at least one individual piece of office supplies 102. In some exemplary embodiments, the distance d₃ may be greater than the length 1 by about 5% to about 25%.

In one exemplary embodiment, chamber 118 is sized to contain a pad 106 of stationary 108. In some exemplary embodiments, each side wall 114, 115, 116, and 117 extends a distance d₁ from the base which is equal to or greater than a thickness t₁ of a pad 106 of stationary 108. In some exemplary embodiments, the distance d₁ may be greater than the thickness t₁ by about 5% to about 25%. In some exemplary embodiments, a distance d₂ between opposing sidewalls 114 and 116 may be equal to or greater than a width w₁ of the pad 106 of stationary 108. In some exemplary embodiments, the distance d₂ may be greater than the width w₁ by about 5% to about 25%. In some exemplary embodiments, a distance d₃ between opposing sidewalls 115 and 117 may be equal to or greater than a length l₁ of the pad 106 of stationary 108. In some exemplary embodiments, the distance d₃ may be greater than the length l₁ by about 5% to about 25%.

Translucent cover 120 overlies, and preferably covers, the chamber 118. Translucent cover 120 may be comprised of any translucent or transparent material which allows light to pass through or be transmitted within itself. On a macroscopic scale, a transparent material is one where the dimensions investigated are at least an order of magnitude larger than the wavelength of the photons in question, the photons can be said to follow Snell's Law. A translucent material is a super-set of transparency and allows light to pass through, but does not necessarily, on a macroscopic scale, follow Snell's law. Light photons passing through a translucent material can be scattered at either of the two interfaces where there is a change in index of refraction, or internally. In some exemplary embodiments, translucent cover 120 comprises any material or medium which allows the transport or transmission of light through that material or medium. In some exemplary embodiments, the translucent cover 120 is made of a transparent or semi-transparent glass or polymer such as plastic. Translucent cover 120 overlies, or lies over, the chamber 118. In the illustrated exemplary embodiment, the translucent cover 120 covers the chamber 118, as shown in FIG. 1, restricting access to the chamber 118.

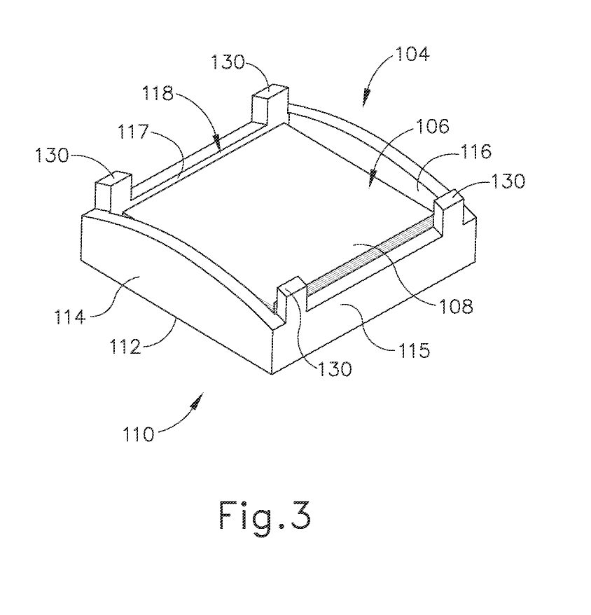

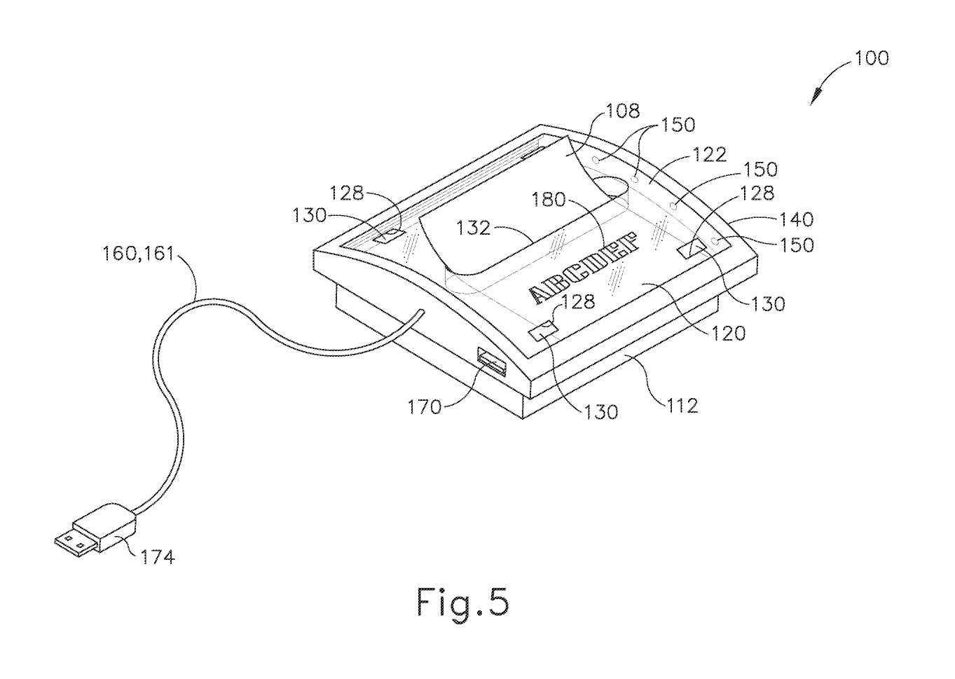

The translucent cover 120 is movably connected with the housing 110 and is movable between a covered position, in which the cover 120 overlies and covers the chamber 118 as shown in FIG. 1, and an open position, in which the cover 120 allows access to the chamber 118 as shown in FIGS. 3 and 6. The translucent cover 120 may be movably connected to the housing 110 in a variety of different manners such as, for example, one or more hinges, snap-fit arrangement, one or more rails allowing sliding movement of the cover 120 relative to the housing 110, etc. In the illustrated exemplary embodiment as shown in FIGS. 1 and 5, the translucent cover 120 defines engagement openings 128 which form a snap-fit arrangement with complimentary engagement members 130 connected with the housing 110, and more particularly, each member 130 connects with a corresponding sidewall 114, 115, 116, or 117.

The translucent cover 120 includes a top surface 122 opposed to a bottom surface 124 and is surrounded by an edge surface 126. The translucent cover 120 forms a dispensing opening 132 from the top surface 122 to the bottom surface 124 and the opening 132 is sized to allow at least one individual piece of office supplies 102 to pass there through. In some exemplary embodiments, the dispensing opening 132 is sized to allow at least a single piece of stationary 108 to pass there through. In the illustrated exemplary embodiment, the dispensing opening 132 is elongated and has a width w₂ (see FIG. 6) which is greater than the width w₁, so as to allow at least a single piece of stationary 108 to pass there through.

The light source 150 is mounted adjacent the edge surface 126. The light source 150 may be any mechanism or device which can emit photons of light, and may be comprised of items such as light bulbs including incandescent light bulbs and fluorescent light bulbs, a light emitting diode, a laser, a halogen lamp, an led lamp, an electroluminescent wire, a xenon lamp, a plasma lamp, a hollow cathode lamp, etc. In some exemplary embodiments, the light source 150 is a powered light source. In such embodiments, the powered light source 150 may receive electrical power in a variety of different manners such as, for example, a battery connected with the light source 150, or any device which generates or transmits electricity and is connected with the light source 150, such as a generator or a power outlet, including a powered USB port. In some exemplary embodiments, the light source 150 is a light emitting diode. The light source 150 may be capable of emitting any wavelength of light or multiple wavelengths of light. In one exemplary embodiment, the light source 150 includes a red light emitting a wavelength of light which appears in color, a green light emitting a wavelength of light which appears green in color, and a blue light emitting a wavelength of light which appears blue in color. The intensity of the red light, the green light, and the blue light may be adjustable by a user so as to combine and form a variety of color combinations.

As shown in FIG. 7, the light source 150 is configured to direct light 154 into the translucent cover 120 through the edge surface 126 in order to illuminate the translucent cover 120. The light source 120 is aimed at the edge surface 126 such that light 154 emitted by the light source 120 is directed through the edge surface 126, into and through the translucent cover 120, and to a second or same edge surface 126 on an opposite end of translucent cover 120 in order to illuminate the translucent cover 120. In this manner, by illuminating the translucent cover 120, the dispenser 100 is more perceivable and is more easily accessible in a darkened environment, and allows a user to more readily obtain individual pieces of stationary 108 in the darkened environment. Furthermore, by aiming the light source 120 at the edge surface 126, the translucent cover 120 is converted into and forms a waveguide which guides light 154 emitted by the light source 150 through the edge surface 126, into and through the translucent cover 120, and to a second or same edge surface 126 on an opposite end of the translucent cover 120. A waveguide is a physical structure that guides electromagnetic waves in the optical spectrum. Common types of waveguides include optical fiber and rectangular waveguides.

Light source 150 is positioned adjacent the edge surface 126, or in some exemplary embodiments, is channeled to the edge surface 126 via a waveguide adjacent the edge surface 126. In some exemplary embodiments, the light source 150 or the waveguide through which light 154 is channeled from the light source 150 to a position adjacent the edge surface 126, may be positioned adjacent the edge surface 126 and be less than about 20 mm from the edge surface 126. In other exemplary embodiments, the light source 150 or waveguide may be less than about 5 mm from the edge surface 126. In further exemplary embodiments, the light source 150 or waveguide may be either touching or less than about 1 mm from the edge surface 126.

Dispenser 100 includes a power cord 160 which supplies power to the light source 150. In one embodiment, the dispenser 100 includes an electrical connector 170 which is any electro-mechanical device which can be used to interface circuitry in the dispenser 100, or circuitry connected with the dispenser 100, with circuitry in a connected device 210. The electrical connector 100 is used to receive digital signals from a connected device 210 and then allows those signals to be transmitted to an external device 200, such as a computer connected with the dispenser 100. For example, the electrical connector 170 may be any one of a number of electrical connectors such as USB connector, a serial port connector, a parallel port connector, a video connector, an HDMI connector, an 8P8C connector, a FIREWIRE™ connector, etc. The dispenser 100 may include a pair of electrical connectors 170, 174, wherein the electrical connector 170 is a female connector and the electrical connector 174 is a male connector. Electrical connector 170 is then used to receive male connectors connected with an external device, such as another computer, a camera, or a memory stick. Electrical connector 174 is preferably connected with the housing 110 via a cable 161.

In one exemplary embodiment, the electrical connector 174 supplies power to the light source 150 via the cable 161. In another exemplary embodiment, the light source 150 is powered by power received from a universal serial bus and is delivered through the cable 161 to the light source 150. In a further exemplary embodiment, both digital signals and power are delivered through the cable 161. In still another exemplary embodiment, the dispenser 100 includes a data hub comprising circuitry for receiving and transmitting digital signals along with an electrical connector 170. For example, the data hub may be a USB hub through which USB connected devices 210, such as memory sticks or cameras, may be connected to and preferably powered. Additionally, information may be transmitted using digital signals from the USB connected devices 210 through the USB hub to an external device 200, such as a computer. The dispenser 100 may be connected with the external device 200 through the electrical connector 174 and also connected with a connected device 210 through the electrical connector 170, allowing for information via digital signals and/or power to be shared and transmitted between the external device 200 and the connected device 210.

In one exemplary embodiment, an image, text, picture, or other indicia 180 (see FIG. 5) may be engraved, molded, or otherwise incorporated on either the top surface 122 or bottom surface 124 of the translucent cover 120. The image 180 may be any image, symbol, graphic, logo, character or characters, or combination thereof. By including the image 180 on either the top surface 122 or bottom surface 124, light 154 transmitted through the translucent cover 120 is able to highlight or contrast the image 180 in order to make the image 180 stand-out and be more visible.

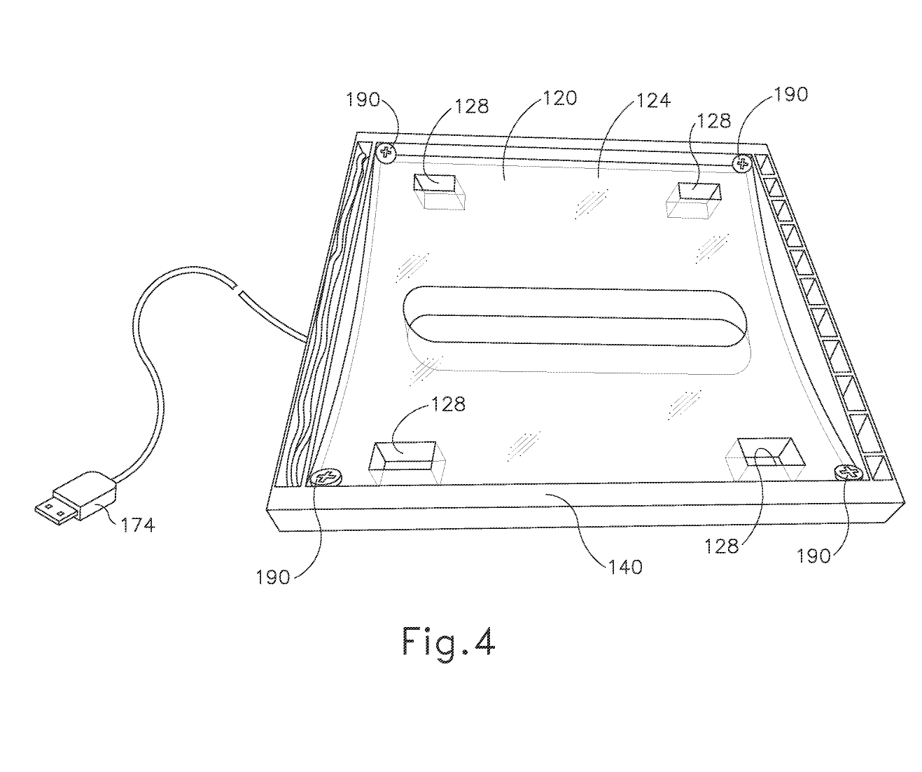

In one exemplary embodiment, the dispenser 100 further comprises a frame 140 surrounding the translucent cover 120. The translucent cover 120 is engaged within grooves formed in the frame 140 and may be fastened to the frame 140 using fasteners 190, as shown in FIG. 4. The light source 150 is embedded in the frame 140 along an inner edge 142 of the frame 140 and adjacent the edge surface 126 of the translucent cover 120, as shown in FIGS. 5-7. The frame 140 is connected with the housing 110 and, more particularly, may be connected with at least one sidewall 114, 115, 116, 117 of the housing 110.

With reference to FIG. 7, in one exemplary embodiment, the light source 150 is an LED light mounted onto a circuit board 220 connected with circuitry used to control the amount of power supplied to the light source 150. In the illustrated exemplary embodiment, the circuit board 220 is embedded into the frame 140.

In operation, power is supplied to the dispenser 100, and specifically the light source 150, via a power cord 160 or cable 161. Upon supplying the power, the light source 150 emits light 154 which is then directed through edge surface 126 of the translucent cover 120 in order to illuminate the translucent cover 120. In one exemplary embodiment, the translucent cover 120 is movable between a covered position, in which the cover 120 overlies and covers the chamber 118, to an open position, in which the cover 120 is positioned upward to allow access to the chamber 118, for example, for removal of at least one individual piece of office supplies 102 from the chamber 118 or insertion of at least one individual piece of office supplies 102 into the chamber 118. The translucent cover 120 then may be moved from the open position to the covered position, overlying and covering the chamber 118.

In one exemplary embodiment, the dispenser 100 defines an opening therein for receiving and retaining a writing utensil.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A stationary dispenser comprising:
a housing including a base and four sidewalls extending from the base forming a chamber sized to contain a pad of stationary, the chamber including an open end;
a translucent cover movably connected with the housing and at least partially positioned in the open end of the chamber, wherein the translucent cover includes a first surface, a second surface opposed to the first surface, and a third surface between the first surface and the second surface, wherein the translucent cover defines an opening therein from the first surface to the second surface through which at least a single piece of stationary may pass; and
a light source mounted adjacent the third surface, wherein the light source is configured to direct light into the translucent cover through the third surface in order to illuminate the translucent cover.

2. The stationary dispenser of claim 1, wherein the cover overlies the open end of the chamber, and wherein the first surface is a top surface of the cover, the second surface is a bottom surface of the cover, and the third surface is an edge surface of the cover.

3. The stationary dispenser of claim 2, wherein the light source is aimed at the edge surface such that light emitted by the light source is directed through the edge surface, into and through the translucent cover, and to one of the edge surface and a second edge surface in order to illuminate the translucent cover.

4. The stationary dispenser of claim 2, further comprising a frame surrounding the translucent cover, wherein the light source is embedded in the frame along an inner edge of the frame and adjacent the edge surface of the translucent cover.

5. The stationary dispenser of claim 4, wherein the light source includes a light emitting diode.

6. The stationary dispenser of claim 1, further comprising an electrical connector for receiving digital signals.

7. The stationary dispenser of claim 1, wherein the light source is powered by power received from a universal serial bus.

8. The stationary dispenser of claim 1, wherein an image is engraved on one of the first surface and the second surface of the translucent cover.

9. The stationary dispenser of claim 1, wherein the light source includes a red light, a green light, and a blue light, and wherein intensities of the red light, the green light, and the blue light are adjustable.

10. The stationary dispenser of claim 1, wherein the translucent cover is movable between a covered position, in which the translucent cover overlies and covers the chamber, and an open position, in which the translucent cover allows access to the chamber.

11. A method of illuminating a dispenser defining a chamber adapted to contain office supplies and including a translucent cover overlying the chamber, the method comprising:
directing light from a powered light source through an edge surface of the translucent cover in order to illuminate the translucent cover.

12. The method of claim 11, further comprising moving the translucent cover from a covered position, in which the translucent cover overlies and covers the chamber, to an open position, in which the translucent cover allows access to the chamber.

13. The method of claim 12, further comprising:
placing office supplies into the chamber; and
moving the translucent cover from the open position to the covered position.

14. The method of claim 11, wherein the office supplies includes one of a paper clip, stationary, a binder clip, and a writing utensil.

15. The method of claim 11, wherein the office supplies includes stationary and the translucent cover includes a top surface, a bottom surface opposed to the top surface, and an edge surface between the top surface and the bottom surface, wherein the translucent cover defines an elongated dispensing opening therein from the top surface to the bottom surface through which at least a single piece of stationary may pass.

16. The method of claim 15, further comprising removing at least a single piece of stationary from the dispenser through the elongated dispensing opening.

17. A dispenser comprising:
a housing including a base and four sidewalls extending from the base forming a chamber sized to contain at least one individual piece of office supplies;
a translucent cover connected with the housing and overlying the chamber, wherein the translucent cover includes a top surface, a bottom surface opposed to the top surface, and an edge surface between the top surface and the bottom surface; and
a light source mounted adjacent the edge surface, wherein the light source is aimed at the edge surface such that light emitted by the light source is directed through the edge surface in order to illuminate the translucent cover.

18. The dispenser of claim 17, wherein the translucent cover is movable between a covered position, in which the cover overlies the chamber, and an open position, in which the cover allows access to the chamber.

19. The dispenser of claim 17, further comprising a frame surrounding the translucent cover, wherein the light source is embedded in the frame along an inner edge of the frame and adjacent the edge surface of the translucent cover.

20. The dispenser of claim 17, wherein the light source is powered by power received from a universal serial bus.
